(19) United States
(12) Patent Application Publication
(10) Pub. No.: US 2012/0252267 A1
(43) Pub. Date: Oct. 4, 2012

(54) CONNECTOR HAVING A TAPERED LOCK JONIT

(75) Inventor: Adam Thomas Nugent, Canastota, NY (US)

(73) Assignee: JOHN MEZZALINGUA ASSOCIATES, INC., East Syracuse, NY (US)

(21) Appl. No.: 13/173,769

(22) Filed: Jun. 30, 2011

Related U.S. Application Data
(60) Provisional application No. 61/469,828, filed on Mar. 31, 2011.

(51) Int. Cl. H01R 9/05; H01R 43/26

(52) U.S. Cl. 439/582; 439/578; 29/857

(57) ABSTRACT

A connector comprising a main body having a first end and a tapered second end, wherein the main body is configured to receive a prepared coaxial cable, and a front body having a tapered first end and a second end, the front body configured to be coupled to the main body, wherein the tapered first end of the front body corresponds to the tapered second end of the main body is provided. Furthermore, an associated method is also provided.

### CROSS-REFERENCE TO RELATED APPLICATIONS

This application is a non-provisional application of U.S. Application No. 61/469,828 filed Mar. 31, 2011, entitled CONNECTOR HAVING A TAPERED LOCK JOINT

### FIELD OF TECHNOLOGY

The following relates to connectors used in coaxial cable communications, and more specifically to embodiments of a connector having a tapered lock joint.

### BACKGROUND

Connectors for coaxial cables are typically connected to complementary interface ports or corresponding connectors to electrically integrate coaxial cables to various electronic devices. The assembly of most coaxial cable connectors requires a mating of two or more components, which typically involves threading one component onto another to secure them together. Using machine threads to join such connector components leads to an adverse change in an electrical performance of the connector because the threads can loosen or tighten over time. Moreover, the point contact made between two threaded components can cause passive intermodulation (PIM) when the threaded components shrink and expand due to heat and other environmental factors. The addition of an adhesive or sealant to correct these deficiencies associated with machine threaded connections not only induces PIM, but requires special care during assembly to avoid over application of the adhesive or sealant. Special care must also be paid when threading the components together to avoid cross-threading the components, which can compromise the structural integrity of the connector.

Thus, a need exists for an apparatus and method for a connector that provides efficient mating of one or more components of the connector.

### SUMMARY

A first general aspect relates to a connector comprising a main body having a first end and a tapered second end, wherein the main body configured to receive a prepared coaxial cable, and a front body having a tapered first end and a second end, the front body configured to be coupled to the main body, wherein the tapered first end of the front body corresponds to the tapered second end of the main body.

A second general aspect relates to a coaxial cable connector comprising: a front body having a first end and a tapered second end, wherein the tapered end includes an annular detent, the annular detent defined by a first tapered surface and a second tapered surface, and a main body having a cable insertion end and a second end, the second end including an annular opening having a narrowing geometry, wherein the narrowing geometry of the annular opening increases a mechanical interference between the annular detent of the front body and the main body.

A third general aspect relates to a connector comprising: a main body main body having a first end and a tapered second end, wherein the main body configured to receive a prepared coaxial cable, a front body having a tapered first end and a second end, the front body configured to be coupled to at least one of an equipment port and a connector, and a means for coupling the front body and the main body, wherein the means includes a taper lock joint.

A fourth aspect relates generally to a method of joining connector components, comprising: providing a main body having a first end and a tapered second end, wherein the main body configured to receive a prepared coaxial cable, a front body having a tapered first end and a second end, the front body configured to be coupled to the main body, wherein the tapered first end of the front body corresponds to the tapered second end of the main body, joining the front body and the main body together, and axially advancing a coaxial cable into a cable insertion end of the main body.

The foregoing and other features of construction and operation will be more readily understood and fully appreciated from the following detailed disclosure, taken in conjunction with accompanying drawings.

### BRIEF DESCRIPTION OF THE DRAWINGS

Some of the embodiments will be described in detail, with reference to the following figures, wherein like designations denote like members, wherein:

FIG. 1 depicts a cross-sectional view of an embodiment of a connector having a tapered lock joint;

FIG. 2A depicts a cut-away perspective view of an embodiment of a coaxial cable;

FIG. 2B depicts a perspective view of an embodiment of the coaxial cable;

FIG. 3 depicts a cross-sectional view of an embodiment of the connector in an open position;

FIG. 4 depicts a perspective view of an embodiment of a main body of the connector;

FIG. 5 depicts a perspective view of an embodiment of a front body of the connector; and

FIG. 6 depicts a cross-sectional view of an embodiment of the connector in a closed position.

### DETAILED DESCRIPTION

A detailed description of the hereinafter described embodiments of the disclosed apparatus and method are presented herein by way of exemplification and not limitation with reference to the Figures. Although certain embodiments are shown and described in detail, it should be understood that various changes and modifications may be made without departing from the scope of the appended claims. The scope of the present disclosure will in no way be limited to the number of constituting components, the materials thereof, the shapes thereof, the relative arrangement thereof, etc., and are disclosed simply as an example of embodiments of the present disclosure.

As a preface to the detailed description, it should be noted that, as used in this specification and the appended claims, the singular forms “a”, “an” and “the” include plural referents, unless the context clearly dictates otherwise.

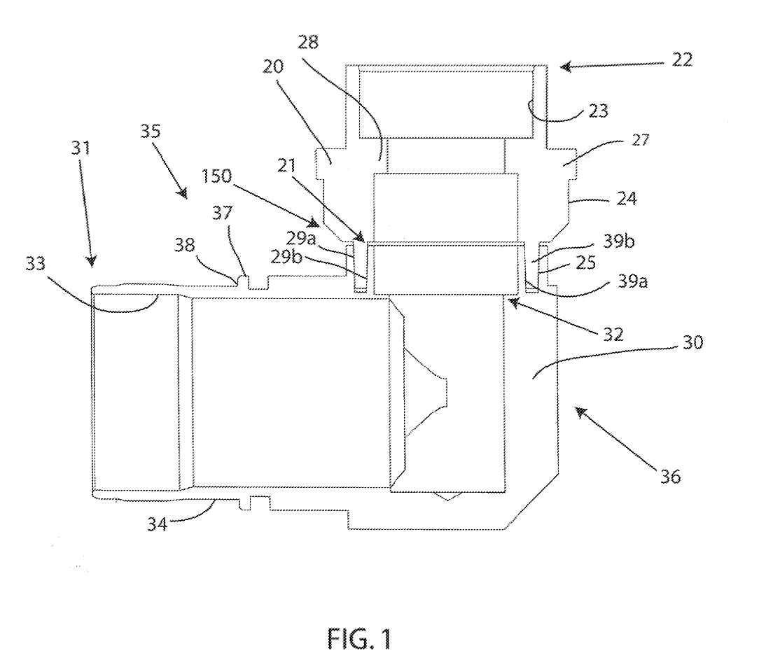

Referring to the drawings, FIG. 1 depicts an embodiment of a connector 100. Connector 100 may be a right angle connector, an angled connector, an elbow connector, an interface port, a straight connector, or any complimentary connector or port that may receive a center conductive strand 18 of a coaxial cable. Further embodiments of connector 100 may receive a center conductive strand 18 of a coaxial cable 10, wherein the coaxial cable 10 includes a corrugated, smoothwall, or otherwise exposed outer conductor 14. Connector 100 can be provided to a user in a preassembled configuration to ease handling and installation during use.

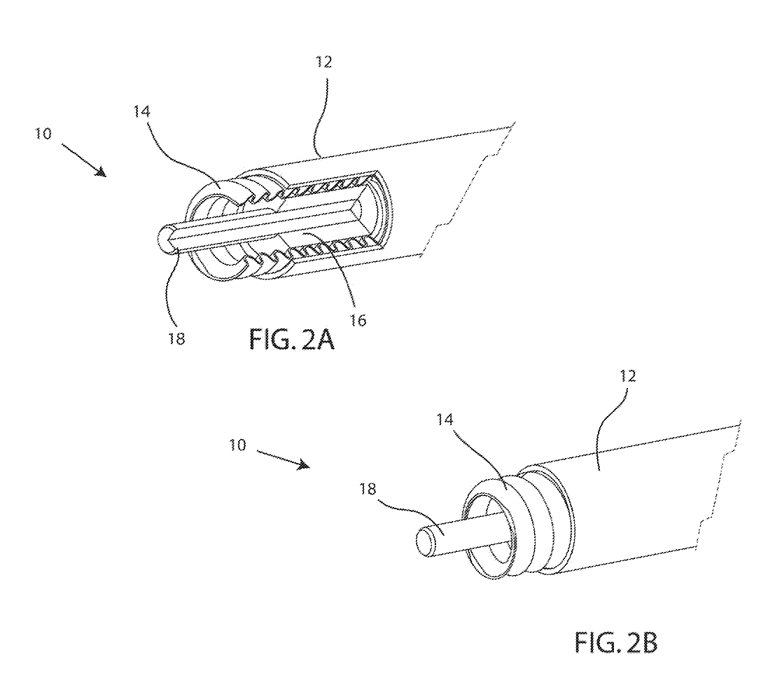

Referring to FIGS. 2A and 2B, embodiments of a coaxial cable 10 may be securely attached to a coaxial cable connector. The coaxial cable 10 may include a center conductive strand 18, surrounded by an interior dielectric 16; the interior dielectric 16 may possibly be surrounded by a conductive foil layer; the interior dielectric 16 (and the possible conductive foil layer) is surrounded by a conductive strand layer 14; the conductive strand layer 14 is surrounded by a protective outer jacket 12, wherein the protective outer jacket 12 has dielectric properties and serves as an insulator. The conductive strand layer 14 may extend a grounding path providing an electromagnetic shield about the center conductive strand 18 of the coaxial cable 10. The conductive strand layer 14 may be a rigid outer conductor of the coaxial cable 10, and may be corrugated or otherwise grooved. The coaxial cable 10 may be prepared by removing the protective outer jacket 12 and coring out a portion of the dielectric 16 (and possibly the conductive foil layer that may tightly surround the interior dielectric 16) surrounding the center conductive strand 18 to expose the outer conductive strand 14 and create a cavity 15 or space between the outer conductive strand 14 and the center conductive strand 18. The protective outer jacket 12 can physically protect the various components of the coaxial cable 10 from damage that may result from exposure to dirt or moisture, and from corrosion. Moreover, the protective outer jacket 12 may serve in some measure to secure the various components of the coaxial cable 10 in a contained cable design that protects the cable 10 from damage related to movement during cable installation. The conductive strand layer 14 can be comprised of conductive materials suitable for carrying electromagnetic signals and/or providing an electrical ground connection or electrical path connection. Various embodiments of the conductive strand layer 14 may be employed to screen unwanted noise. In some embodiments, there may be flooding compounds protecting the conductive strand layer 14. The dielectric 16 may be comprised of materials suitable for electrical insulation. The protective outer jacket 12 may also be comprised of materials suitable for electrical insulation. It should be noted that the various materials of which all the various components of the coaxial cable 10 should have some degree of elasticity allowing the cable 10 to flex or bend in accordance with traditional broadband communications standards, installation methods and/or equipment. It should further be recognized that the radial thickness of the coaxial cable 10, protective outer jacket 12, conductive strand layer 14, possible conductive foil layer, interior dielectric 16 and/or center conductive strand 18 may vary based upon generally recognized parameters corresponding to broadband communication standards and/or equipment.

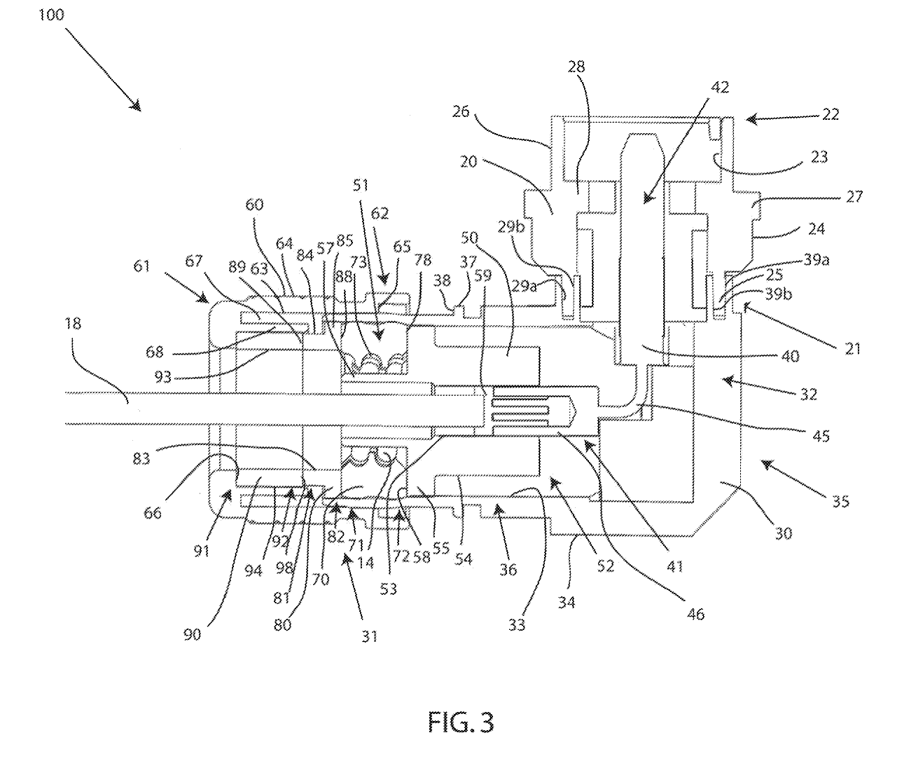

Referring now to FIG. 3, embodiments of connector 100 may include a main body 30, a front body 20, a contact 40, an insulator body 50, an outer conductive engagement member 70, a flanged collar 80, a collar 90, and a fastener member 60. Further embodiments of connector 100 may include a main body 30 having a first end 31 and a tapered second end 32, wherein the main body 30 is configured to receive a prepared coaxial cable 10, and a front body 20 having a tapered first end 21 and a second end 22, the front body 20 configured to be coupled to the main body 30, wherein the tapered first end 21 of the front body 20 corresponds to the tapered second end 32 of the main body 30.

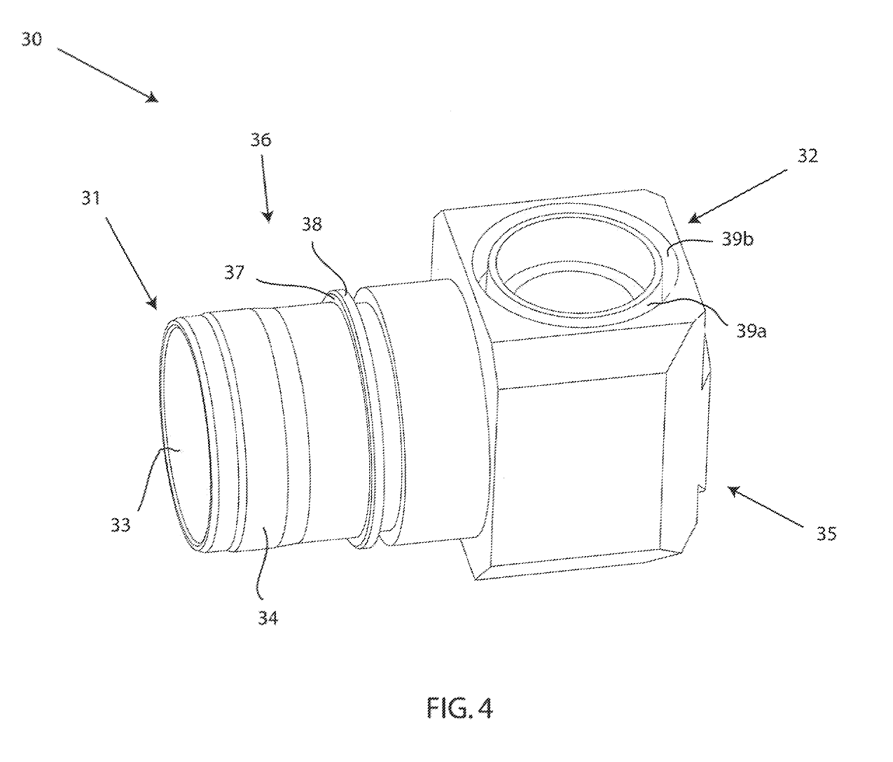

With continued reference to FIG. 3, and additional reference to FIG. 4, embodiments of connector 100 may include a main body 30. Main body 30 may include a first end 31, a second end 32, an inner surface 33, and an outer surface 34. Main body 30 may further include a first portion 35 and a second portion 36. The first portion 35 of the main body 30 may be proximate the second end 32, and may have a generally axial opening in a longitudinal, or substantially longitudinal, direction. Embodiments of the main body 30, or the first portion 35 of the main body 30, may also include a tapered second end 32. In other words, the second end 32 of the main body 30 may taper inwards from an edge of the second end 32. For instance, the main body 30 may include a first tapered surface 39a and a second tapered surface 39b proximate the second end 32 of the main body 30. The first and second tapered surface 39a, 39b may share a concentric relationship, wherein the first and second tapered surface 39a, 39b are radially separated by a distance to accommodate a tapered first end 21 of the front body 20. The radial separation between the first tapered surface 39a and the second tapered surface 39b may create an annular opening or cavity which may snugly accept the tapered first end 21 of the front body. Thus, the annular opening between the first and the second tapered surface 39a, 39b may become gradually narrower the further away from the edge of the main body 30 proximate the tapered second end 32. The narrowing of the annular opening created by the tapered surfaces 39a, 39b increases a mechanical interference or physical communication between the front body 20 and the main body 30 as the front body 20 is mated with the main body 30. The increased mechanical interference caused by the first and second tapered surfaces 39a, 39b making up the tapered second end 32 of the main body 30 may allow a technician or an assembler to use a forced press-fit to both secure and seal the main body 30 and the front body 20. Further embodiments of the tapered second end 32 of the main body 30 may include only one of the first tapered surface 39a and the second tapered surface 39b. For example, the tapered second end 32 of the main body 30 may include one or two tapered surfaces to operably mate with the front body 20.

The second portion 36 of the main body 30 may extend from the first portion 35, and may be structurally integral with the first portion 35, or may be structurally independent (e.g. utilization of a coupling means) of the first portion 35 of the main body 30. Moreover, the second portion 36 may have a generally axial opening in a latitudinal, or substantially latitudinal, direction. The generally axial opening of the second portion 36 may extend from proximate the first end 31 and may be in communication with the generally axial opening of the first portion 35. The opening of the main body 30, or the second portion 36 of the main body 30, may include narrowing geometry to compress squeeze the outer conductor engagement member 70, causing deflection of the outer conductor engagement member 70 to clamp the outer conductor 14. For example, the opening within the main body 30 may taper gradually, causing the inner diameter to gradually decrease from the first end 31 to the second end 32 of the main body. Alternatively, the inner surface 33 of the main body may have a surface feature, such as a protrusion, ramped portion, bump, annular barb, and the like, that narrows the opening within the main body 30 to compress the outer conductor engagement member 70. The generally axial opening of the second portion 36 of the main body 30 may have an internal diameter large enough to allow an insulator body 50, an outer conductor engagement member 70, a flanged collar 80, a collar 90, and portions of a coaxial cable 10 to enter and remain disposed within the main body 30 while operably configured; however, the opening within the second portion 36 may decrease in diameter gradually or at one or more points to compress the outer conductor engagement member 70. In other words, the outer conductor engagement member 70 and other internal components may be radially compressed by the inner surface 33 of the main body 30 as the components are driven axially along within the main body 30. The generally axial opening of the second portion 36 of the main body 30 may have an internal diameter large enough to allow an insulator body 50, a flanged collar 80, a collar 90, and portions of a coaxial cable 10 to enter and remain disposed within the main body 30 while operably configured. Embodiments of the main body 30 may include an annular protrusion 37 which may protrude or extend a distance from the outer surface 34 of the main body 30; the annular protrusion 37 may be disposed around the second portion 36 of the main body 30. The annular protrusion 37 may include a mating edge 38 (i.e. a face/side of the annular protrusion 37 which faces the first end 31 of the main body 30) that can mate with a mating edge, such as annular recessed portion 65 of a fastener member 60 while in a closed, or fully compressed, position. In addition, the main body 30 may be formed of metals or polymers or other materials that would facilitate a rigidly formed body. Manufacture of the main body 30 may include casting, extruding, cutting, turning, tapping, drilling, injection molding, blow molding, or other fabrication methods that may provide efficient production of the component. Those in the art should appreciate that various embodiments of the main body 30 may also comprise various inner or outer surface features, such as annular grooves, detents, tapers, recesses, and the like, and may include one or more structural components having insulating properties located within the main body 30.

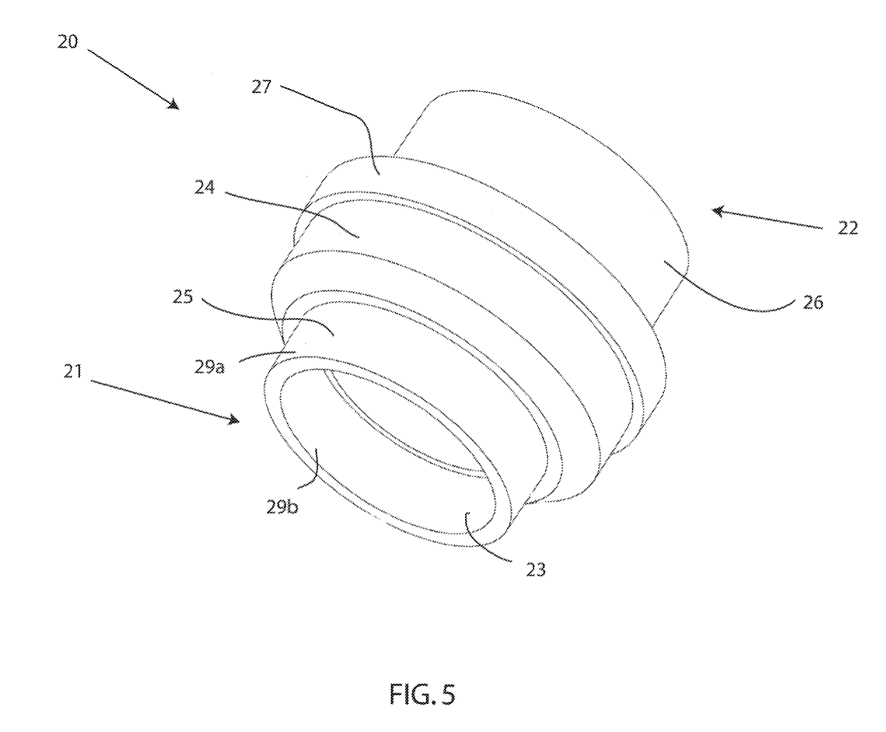

Referring still to FIG. 3, and with additional reference to FIG. 5, embodiments of connector 100 may include a front body 20. The front body 20 may include a first end 21, a second end 22, an inner surface 23, and an outer surface 24. The front body 20 may include a generally axial opening extending from the first end 21 to the second end 22. Embodiments of the front body 20 may also include a tapered first end 21. In other words, the first end 21 of the front body 20 may taper inwards towards the edge of the first end 21. The tapered first end 21 of the front body 20 may correspond to the tapered second end 32 of the main body 30. Moreover, the tapered first end 21 of the front body 20 may be 20 a tapered annular detent 25. The tapered annular detent 25 may be sized and dimensioned to fit within the generally axial opening of the first portion 35 of the main body 30. In most embodiments, the tapered annular detent 25 may be sized and dimensioned to snugly fit within the annular opening or cavity between the first and second tapered surfaces 39a, 39b of the main body 30. Embodiments of the tapered annular detent 25 may include a first tapered surface 29a and a second tapered surface 29b. The first tapered surface 29a may be an outer surface, such as outer surface 24, of the tapered annular detent 25. Conversely, the second tapered surface 29b may be an inner surface, such as inner surface 23, of the tapered annular detent 25. Thus, the thickness of the tapered annular detent 25 defined by the first and the second tapered surface 29a, 29b may become gradually narrower the closer to the edge of the front body 20 proximate the tapered first end 21. The narrowing thickness of the tapered annular detent 25 created by the inner and outer tapered surfaces 29a, 29b can correspond to the narrowing annular opening created by the first and second tapered surface 39a, 39b of the main body 30. For example, the first and second tapered surfaces 39a, 39b of the main body 30 are opposingly tapered surfaces with respect to the first and second tapered surfaces 29a, 29b of the front body 20, respectively. The tapered geometry of the tapered second end 32 of the main body 30 coupled with the tapered geometry of the tapered annular detent 25 can increase a mechanical interference or physical communication between the front body 20 and the main body 30 as the front body 20 is mated with the main body 30. The increased mechanical interference caused by the opposing or corresponding relationship between the first and second tapered surfaces 39a, 39b making up the tapered second end 32 of the main body 30 and the tapered annular detent 25 of the front body 20 may allow a technician or an assembler to simply push the front body 20 onto the main body 30 to secure the two components. Pushing, or otherwise forcing, the front body 20 onto the main body 30 may both secure and seal the components together due to press-fit connection between the tapered second end 32 of the main body 30 and the tapered first end 21 of the front body 20. Further embodiments of the tapered first end 21 of the front body 20 may include only one of the first tapered surface 29a and the second tapered surface 29b. For example, the tapered first end 21 of the front body 20 may include one or two tapered surfaces to operably mate with the main body (i.e. front body 20, or annular detent 25, may include an internally tapered surface or an externally tapered surface).

Moreover, the front body 20 may include an annular recessed portion 26 proximate or otherwise near the second end 22. The annular recessed portion 26 may create a flange 27 extending annularly around the front body 20. Embodiments of the front body 20 may also include an internal protrusion 28 which may protrude or extend a distance from the inner surface 23 of the front body 20. The front body 20 may also be configured to connect, accommodate, receive, or couple with an additional coaxial cable connector. In addition, the front body 20 may be formed of metals or polymers or other materials that would facilitate a rigidly formed body. Manufacture of the front body 20 may include casting, extruding, cutting, turning, tapping, drilling, injection molding, blow molding, or other fabrication methods that may provide efficient production of the component. Those in the art should appreciate that various embodiments of the front body 20 may also comprise various inner or outer surface features, such as annular grooves, detents, tapers, recesses, and the like, and may include one or more structural components having insulating properties located within the front body 20.

With continued reference to FIG. 3, embodiments of connector 100 may include a contact 40. Contact 40 may include a first end 41 and a second end 42. Further embodiments of connector 100 may include a contact 40 wherein a portion of the contact 40 may be disposed within the main body 30, and another portion may be disposed within the front body 20. Contact 40 may be a conductive element that may extend or carry an electrical current and/or signal from a first point to a second point. Contact 40 may be a terminal, a pin, a conductor, an electrical contact, and may be straight for straight connectors, or a curved, bended, angled, etc. contact for a right angle connector. Contact 40 may further include a connection portion 45 that may connect, or otherwise be disposed between, the first end 41 and the second end 42; the connection portion 45 may be structurally integral with the other portions of contact 40. Contact 40 may have various diameters, sizes, and may be arranged in any alignment throughout the connector 100, depending on the shape or orientation of the connection portion 45. For example, embodiments of connection portion 45 may be curved or otherwise non-linear in shape to achieve a curve-shaped contact 40. Further embodiments of contact 40 may include a bended or curved connection portion 45 to from a contact 40 that forms a right angle (i.e. 90), or a substantially right angle. The contact 40, including the connection portion 45 of the contact 40 should be formed of conductive materials. Embodiments of contact 40 may include a socket 46 proximate or otherwise near the first end 41. The socket 46 may be a conductive center conductor clamp that accepts, receives, and/or accommodates the center conductive strand 18.

Referring still to FIG. 3, embodiments of connector 100 may include an insulator body 50. The insulator body 50 may include a first end 51, a second end 52, an internal surface 53, and an outer surface 54. The insulator body 50 may be disposed within the main body 30. For example, the insulator body 50 may be disposed or otherwise located in the generally axial opening of the second portion 36 of the main body 30. The insulator body 50 may further include an opening 59 extending axially through the insulator body 50 from the first end 51 to the second end 52. The opening 59 may be a bore, hole, channel, tunnel, and the like. The insulator body 50, in particular, the opening 59 of the insulator body 50 may accept, receive, accommodate, etc., an incoming center conductive strand 18 of the coaxial cable 10 as a coaxial cable 10 is further inserted into the main body 30. The diameter or general size of the opening 59 should be large enough to accept the center conductive strand 18 of the coaxial cable 10, and may be approximately the same or slightly larger in diameter or general size of the socket 46 of contact 40. Moreover, embodiments of the insulator body 50 may include an annularly extending protrusion 55 which may protrude or extend a distance from the outer surface 54 of the insulator body 50. The diameter of the flange 55 may be substantially the same or slightly smaller than the diameter of the generally axial opening of the second portion 36 of the main body 30 to allow axial displacement of the insulator body 50 within the main body 30. The annular protrusion 55 may include a mating edge 58 (i.e. a face/side of the annular protrusion 55 which faces the first end 51 of the insulator body 50) that can mate with a mating edge 78 of an outer conductor engagement member 70, and a portion of the outer conductor 14 as the coaxial cable 10 is advanced through the main body 30. Further embodiments of the insulator body 50 may include an annular detent 57 proximate or otherwise near the first end 51 of the insulator body 50. The annular detent 57 may be sized and dimensioned to enter cavity 15 of the coaxial cable 10, wherein the cavity 15 is created when a portion of the dielectric 16 surrounding the center conductive strand 18 is removed or cored. The annular detent 57 may engage the dielectric 16, in particular a mating edge of the dielectric as the cable 10 is advanced into the main body 30. Thus, the annular detent 57 of the insulator body 50 may be disposed between the outer conductor 14 and the center conductive strand 18 in a closed position. Furthermore, the insulator body 50 should be made of non-conductive, insulator materials. Manufacture of the insulator body 50 may include casting, extruding, cutting, turning, drilling, compression molding, injection molding, spraying, or other fabrication methods that may provide efficient production of the component.

Referring again to FIG. 3, embodiments of connector 100 may include an outer conductor engagement member 70. The outer conductor engagement member 70 may include a first end 71, a second end 72, a threaded internal surface 73, and an outer surface 74. The outer conductor engagement member 70 may be disposed within the main body 30 proximate or otherwise near the insulator body 50. For instance, the outer conductive engagement member 70 may be disposed between the flanged collar 80 and the insulator body 50. Moreover, the outer conductor engagement member 70 may be disposed around the outer conductive strand 14, wherein the threaded internal surface 73 may threadably engage the outer conductive strand 14. For example, the threaded internal surface 73 may include threads or grooves that may correspond to the threads or grooves of the outer conductive strand 14. Further embodiments of the outer conductive engagement member 70 may include a first mating edge 78 proximate or otherwise near the second end 72 and a second mating edge 79 proximate or otherwise near the first end 71. The first mating edge 78 may engage the mating edge 58 of the insulator body 50 as the coaxial cable 10 is further inserted into the axial opening of the main body 30. Similarly, the second mating edge 79 may engage a first mating edge 88 of the flange collar 80 as the coaxial cable is advanced through the main body 30 proximate the first end 31. Furthermore, the outer conductor engagement member 70 should be made of non-conductive, insulator materials. Manufacture of the outer conductive engagement member 70 may include casting, extruding, cutting, turning, drilling, compression molding, injection molding, spraying, or other fabrication methods that may provide efficient production of the component.

Embodiments of connector 100 may further include a flanged collar 80. The flanged collar 80 may include a first end 81, a second end 82, an inner surface 83, and an outer surface 84. The flanged collar 80 may be a generally annular tubular member. The flanged collar 80 may be disposed within the main body 30 proximate or otherwise near the outer conductive engagement member 70. For instance, flanged collar 80 may be disposed between the collar 90 and the outer conductive engagement member 70. Moreover, the flanged collar 80 may be disposed around the dielectric 16 of the coaxial cable 10 when the cable 10 enters the connector 100. Further embodiments of the flanged collar 80 can include a flange 85 proximate or otherwise near the second end 82. The flange 85 may protrude or extend a distance from the outer surface 84. The flange 85 may create a space or cavity between the outer surface 84 of the flanged collar 85 and the inner surface 33 of the main body 30 to allow a portion of the fastener member 60 to slide between the flanged collar 80 and the main body 30 as the connector 100 is moved into the closed position. The flanged collar 80 may also include a mating edge 88 proximate or otherwise near the second end 82 that may engage the second mating edge 79 of the outer conductor engagement member 70 as the coaxial cable 10 is further inserted into the axial opening of the main body 30. Additionally, the flanged collar 80 should be made of non-conductive, insulator materials. Manufacture of the flanged collar 80 may include casting, extruding, cutting, turning, drilling, compression molding, injection molding, spraying, or other fabrication methods that may provide efficient production of the component.

With reference still to FIG. 3, embodiments of connector 100 may include a collar 90. The collar 90 may include a first end 91, a second end 92, an inner surface 93, and an outer surface 94. The collar 90 may be a generally annular tubular member. The collar 90 may be a solid sleeve collar and may be disposed within the main body 30 proximate or otherwise near the flanged collar 80. For instance, collar 90 may be disposed around the dielectric 16 of the coaxial cable 10 when the cable 10 enters the connector 100. Further embodiments of the collar 90 may also include a mating edge 98 proximate or otherwise near the second end 92 that may engage the flanged collar 90 as the coaxial cable 10 is further inserted into the axial opening of the main body 30. Additionally, the collar 90 should be made of non-conductive, insulator materials. Manufacture of the collar 90 may include casting, extruding, cutting, turning, drilling, compression molding, injection molding, spraying, or other fabrication methods that may provide efficient production of the component.

Embodiments of connector 100 may also include a fastener member 60. The fastener member 60 may have a first end 61, second end 62, inner surface 63, and outer surface 64. The fastener member 60 may be a generally annular member having a generally axial opening therethrough. The fastener member 60 may be disposed over or around a portion of the main body 30. For instance, the fastener member 60 may surround the second portion 36 of the main body 30. Proximate or otherwise near the second end 62, the fastener member 60 may include an internal annular recessed portion 65. The internal annular recessed portion 65 may engage the mating edge 38 of the annular protrusion 37 of the main body 30 as the connector 100 moves from an open to a closed position. For instance, the fastener member 60 may axially slide towards the second end 32 of the main body 30 until the internal recessed portion 65 physically or mechanically engages the annular protrusion 37 of the main body 30. Moreover, the fastener member 60 may include an annular lip 66 proximate or otherwise near the first end 61. The annular lip 66 may be configured to engage the collar 90 as the connector 100 is moved to a closed position. The fastener member 60 may further include a cavity 67 proximate or otherwise near the second end 62. The cavity 67 may be a space, opening, void, and the like, which may be located between the inner surface 63 of the fastener member 60 and an inner portion 68. The inner portion 68 may be an annular member which can be parallel to the outer structural surface of the fastener member 60. Embodiments of the inner portion 68 may be structurally integral with the fastener member 60 and may extend a distance into the generally axially opening of the fastener member 60, while maintaining a radial distance from the inner surface 63 of the fastener member 60. The inner portion 68 may surround or substantially surround the dielectric 16 of the coaxial cable 10 when the cable 10 is present in the connector 100. The cavity 67 may accommodate, receive, accept, etc., a portion of the main body 30 as the fastener member 60 is axially displaced onto the main body 30. Furthermore, it should be recognized, by those skilled in the requisite art, that the fastener member 60 may be formed of rigid materials such as metals, hard plastics, polymers, composites and the like, and/or combinations thereof. The fastener member 60 may be manufactured via casting, extruding, cutting, turning, drilling, knurling, injection molding, spraying, blow molding, component overmolding, combinations thereof, or other fabrication methods that may provide efficient production of the component.

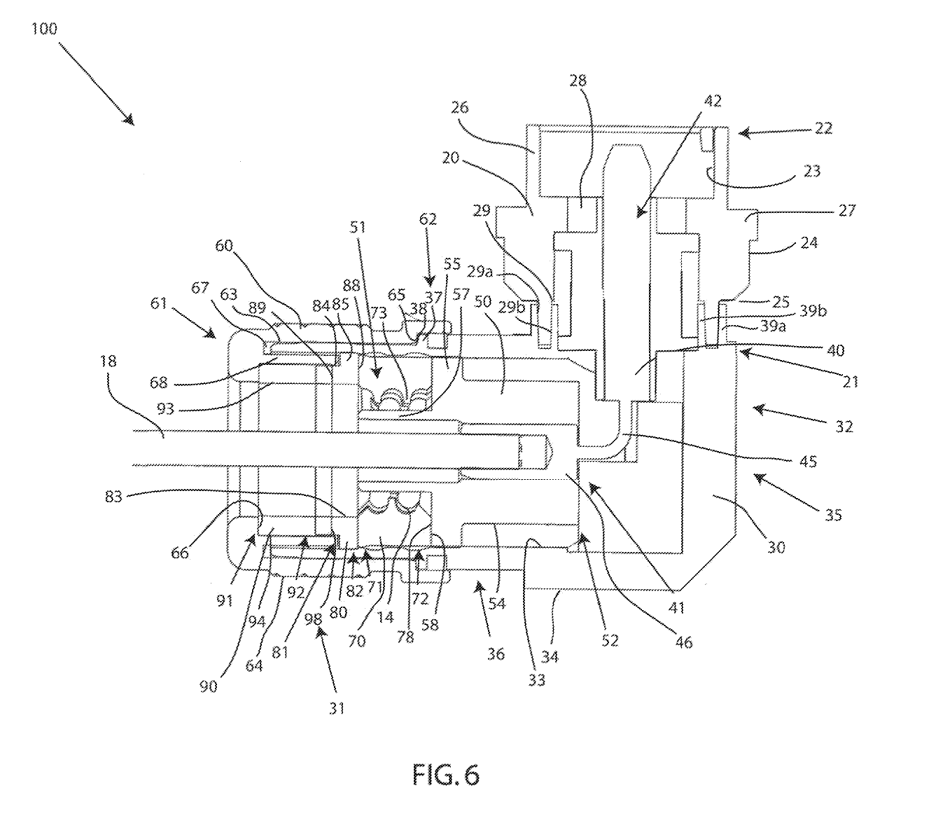

Referring now to FIGS. 3 and FIG. 6, the manner in which connector 100 may move from an open position to a closed position is now described. FIG. 3 depicts an embodiment of the connector 100 in an open position. The open position may refer to a position or arrangement wherein the center conductive strand 18 of the coaxial cable 10 is not inserted into the socket 46 of contact 40, or only partially/initially inserted into the socket 46. The cable 10 may enter the generally axially opening of the fastener member 60, and the outer conductive strand 14 engages the outer conductor engagement member 70. The outer conductive strand 14 may mate with the outer conductive engagement member 70. For example, the outer conductive strand 14 may be threaded onto the outer conductive engagement 70, or may be simply pushed (axially) further into the main body 30. In some embodiments, the connector 100 may be rotated or twisted to provide the necessary rotational movement of the outer conductive engagement member 70 to mechanically engage, or threadably engage, the outer conductive strand 14. Alternatively, in other embodiments, the coaxial cable 10 may be rotated or twisted to provide the necessary rotational movement of the outer conductive engagement member 70 to mechanically engage, or threadably engage, the outer conductive strand 14. The engagement between the outer conductive strand 14 and the outer conductive engagement member 70 may establish a mechanical connection between the connector 100 and the coaxial cable 10. Those skilled in the art should appreciate that mechanical communication or interference may be established without threadably engaging an outer conductive strand 14, such as friction fit between the cable 10 and the connector 100.

FIG. 6 depicts an embodiment of a closed position of the connector 100. The closed position may refer to a position or arrangement of the connector 100 wherein the center conductive strand 18 is fully or substantially inserted into the socket 46 of contact 40. The closed position may be achieved by axially compressing the fastener member 60 onto the connector 100. For instance, the first end 61 of the fastener member 60 may extend an axial distance so that, when the fastener member 60 is axially compressed into a sealing position on the coaxial cable 100, the fastener member 60 may touch or reside proximate or otherwise near the first portion 35 of the main body 30. The axial movement of the fastener member 60 can axially displace the cable 10 and other components disposed within the main body 30 because of the mechanical engagement between the lip 66 of the fastener member 60 and the collar 90. The collar 90 may then mechanically engage the flanged collar 80, which may mechanically engage the outer conductive engagement member 70. The outer conductive engagement member 70 may engage the insulator body 50 to axially displace the insulator body 50 further onto the socket 46, but may also axially displace the cable 10 due to mechanical interference with the outer conductive strand 14. Therefore, the center conductive strand 18 is inserted into the socket 46 of the contact 40 in the closed position.

Referring back to FIG. 1, an embodiment of the connector 100 utilizing a taper lock joint 150 is shown. Embodiments of the main body 30 and the front body 20 may be machined, or otherwise manufactured and designed in such a way that the main body 30 and the front body 20 can be pushed together and locked. The mating or coupling of the tapered second end 32 of the main body 30 and the tapered first end 21 of the front body 30 may be referred to as a taper lock joint 150. The taper lock joint 150 can incorporate a locking taper of both the main body 30 and the front body 20 (i.e. one or more tapered surface of the main body 30 and the front body 20). Providing a taper lock joint 150 between at least two components of connector 100 instead of a threaded connection may eliminate the need to use an adhesive or sealant, such as Lock-Tite®, to reduce the tightening and/or loosening of the machine threads over time, and may avoid errors occurring during assembly, such as cross-threading the at least two components together. Furthermore, locking tapered surfaces, such as surfaces 29a, 29b, 39a, 39b of the front body 20 and the main body 30, respectively, of the locking taper joint 150 may provide an uninterrupted path for RF to flow, which may eliminate the PIM caused by the point contact of threads. Because the locking taper joint 150 may allow two components, such as a main body 30 and a front body 20, to be pressed together to removably secure the components together, the amount of time it takes to join the components together may be reduced and the assembly process simplified. Even further advantages of a taper lock joint 150 of connector 100 (e.g. utilization of tapered surfaces 29a, 29b, 39a, 39b) and the press-fit connection may include avoiding the use of an O-ring, which may further simplify the assembly process and reduce the number of components of connector 100.

Referring now to FIGS. 1-6, a method of joining connector components may comprise the steps of a method of joining connector components, comprising: providing a main body 30 having a first end 31 and a tapered second end 32, wherein the main body 30 is configured to receive a prepared coaxial cable 10, a front body 20 having a tapered first end 21 and a second end 22, the front body 20 configured to be coupled to the main body 30, wherein the tapered first end 21 of the front body 20 corresponds to the tapered second end 32 of the main body 30, joining the front body 20 and the main body 30 together, and axially advancing a coaxial cable 10 into a cable insertion end 31 of the main body.

While this disclosure has been described in conjunction with the specific embodiments outlined above, it is evident that many alternatives, modifications and variations will be apparent to those skilled in the art. Accordingly, the preferred embodiments of the present disclosure as set forth above are intended to be illustrative, not limiting. Various changes may be made without departing from the spirit and scope of the invention, as required by the following claims. The claims provide the scope of the coverage of the invention and should not be limited to the specific examples provided herein.

What is claimed is:

1. A connector comprising:
a main body having a first end and a tapered second end, wherein the main body configured to receive a prepared coaxial cable; and
a front body having a tapered first end and a second end, the front body configured to be coupled to the main body;
wherein the tapered first end of the front body corresponds to the tapered second end of the main body.

2. The connector of claim 1, further comprising:
an electrical contact having a socket, the socket disposed within the main body and configured to receive a center conductive strand of the coaxial cable; and
an insulator body disposed within the main body, the insulator body having a first end and a second end.

3. The connector of claim 1, wherein a collar is disposed proximate the first end of the main body to form a seal around the coaxial cable.

4. The connector of claim 1, further comprising:
a fastener member configured to be axially compressed onto the main body.

5. The connector of claim 1, wherein the connector is a right angle connector.

6. The connector of claim 1, wherein the connector is a straight connector.

7. A coaxial cable connector comprising:
a front body having a first end and a tapered second end, wherein the tapered end includes an annular detent, the annular detent defined by a first tapered surface and a second tapered surface; and
a main body having a cable insertion end and a second end, the second end including an annular opening having a narrowing geometry, wherein the narrowing geometry of the annular opening increases a mechanical interference between the annular detent of the front body and the main body.

8. The connector of claim 7, further comprising:
an electrical contact having a socket, the socket disposed within the main body and configured to receive a center conductive strand of the coaxial cable; and
an insulator body disposed within the main body, the insulator body having a first end and a second end.

9. The connector of claim 7, wherein a collar is disposed proximate the first end of the main body to form a seal around the coaxial cable.

10. The connector of claim 7, further comprising:
a fastener member configured to be axially compressed onto the main body.

11. The connector of claim 7, wherein the connector is a right angle connector.

12. The connector of claim 7, wherein the connector is a straight connector.

13. A connector comprising:
a main body main body having a first end and a tapered second end, wherein the main body configured to receive a prepared coaxial cable;
a front body having a tapered first end and a second end, the front body configured to be coupled to at least one of an equipment port and a connector; and
a means for coupling the front body and the main body, wherein the means includes a taper lock joint.

14. The connector of claim 13, further comprising:
an electrical contact having a socket, the socket disposed within the main body and configured to receive a center conductive strand of the coaxial cable;
an insulator body disposed within the main body, the insulator body having a first end and a second end; and
a fastener member configured to be axially compressed onto the main body.

15. The connector of claim 13, wherein the connector is a right angle connector.

16. The connector of claim 13, wherein the connector is a straight connector.

17. A method of joining connector components, comprising:
providing a main body having a first end and a tapered second end, wherein the main body configured to receive a prepared coaxial cable, a front body having a tapered first end and a second end, the front body configured to be coupled to the main body, wherein the tapered first end of the front body corresponds to the tapered second end of the main body;
joining the front body and the main body together; and
axially advancing a coaxial cable into a cable insertion end of the main body.

18. The method of claim 17, wherein joining the front body and the main body includes pushing them together without threading.

19. The method of claim 17, further comprising:
an electrical contact having a socket, the socket disposed within the main body and configured to receive a center conductive strand of the coaxial cable;
an insulator body disposed within the main body, the insulator body having a first end and a second end; and
a fastener member configured to be axially compressed onto the main body.

20. The method of claim 17, wherein the connector is a right angle connector.

21. The method of claim 17, wherein the connector is a straight connector.
